(19) United States
(12) Patent Application Publication
(10) Pub. No.: US 2019/0018901 A1
(43) Pub. Date: Jan. 17, 2019

(54) SYSTEMS AND METHODS FOR OBJECT ANALYSIS AND EXPLORATION ON SOCIAL NETWORKS

(71) Applicant: Carnegi X Inc., Taipei (TW)

(72) Inventor: Hui-Lung LIN, Taipei (TW)

(21) Appl. No.: 16/070,179

(22) PCT Filed: Jan. 15, 2016
(86) PCT No.: PCT/US2016/013496

§ 371 Date: Jul. 13, 2018

(51) Int. Cl. G06F 17/30

(52) U.S. Cl. CPC G06F 17/30867; G06Q 50/01; G06F 17/30719; G06F 17/30946

(57) ABSTRACT

Systems, software, networks, and methods for analyzing, managing, and exploring property of a plurality of objects encoding a type of association or relation between a user and an object on social networks are described herein. The subject matter of the technology disclosed herein improves a computing system to analyze, manage, activate, match, screen, and explore objects on social networks. Analyses, management (e.g., activation, screening) and exploration turn objects into desired or supplied information. In some embodiments, analyses, management (e.g., activation, screening) and exploration remove unnecessary or unwanted information contained within objects. For the purpose of explanation, examples of contact/connection/friend/individual management and exploration system are given below. Other non-limiting examples include management and exploration systems of files, documents, images, videos, audios, skills, expertises, contextual needs, or a combination thereof.

### BACKGROUND OF THE INVENTION

Social networks have become a vehicle to maintain social connections. There are a number of objects on social networks. Examples of objects include contacts, connections, companies, articles, skills, images, video files, audio files, maps, movies, etc. Objects on social networks grow exponentially. As such, analyzing, managing, matching and exploring objects (e.g., a contact management system, a photo or video management system, a digital music streaming system, a webpage search system, a dating system, a co-working system . . . , etc.) for a user's effective use becomes a more difficult task.

### SUMMARY OF THE INVENTION

The subject matter of the technology disclosed herein improves a computing system to analyze, manage, activate, match, screen, and explore objects on social networks. Analyses, management (e.g., activation, screening) and exploration turn objects into desired or supplied information. In some embodiments, analyses, management (e.g., activation, screening) and exploration remove unnecessary or unwanted information contained within objects. For the purpose of explanation, examples of contact/connection/friend/individual management and exploration system are given below. Other non-limiting examples include management and exploration systems of files, documents, images, videos, audios, skills, expertises, contextual needs, or a combination thereof.

Specifically, an example of a contact and connections management system is given in this disclosure. A contact management system models a user's contacts as a mathematical graph based on social linkages or based on features (e.g., traits, skills, education, expertise, etc.). Analysis on the graph enables the user to efficiently utilize the information hidden in the contact database. The system automatically analyzes the contacts and further provides linkage to external databases, such as social network service providers (e.g., Facebook, Twitter, Instagram, Pinterest . . . , etc.), e-commerce entities, third-party payment, meet-up activities, public welfare organizations, family members, cloud services, web services, telcoes, ISPs, government, and other open platforms. Contact information along with various types of analyzed, evaluated, updated, identified, and screened information can enhance efficiency and efficacy of contact management.

In one aspect, disclosed herein is a computing system comprising one or more physical processors in communication with one or more data storage systems (such as one or more memory modules), and an object analysis and exploration module configured to search, and evaluate property of a plurality of objects encoding a type of association or relation between a user and an object.

In another aspect provides a computing system comprising a physical processor, a memory module, and an operating system configured to execute computer readable instructions, wherein the computer readable instructions comprise an object analysis and exploration module configured to search and evaluate property of a plurality of objects encoding a type of association or relation between a user and an object.

In another aspect provided herein is a method implemented by the computer system disclosed herein for searching, and evaluating property of a plurality of objects encoding a type of association or relation between a user and an object in a computing system.

In another aspect provided herein is a method for searching, rewarding, and evaluating property, of a plurality of objects encoding a type of association or relation between a user and an object in a computing system.

In another aspect provided herein is a method for matching, rewarding, and evaluating property, of a plurality of objects encoding a type of association or relation between a user and an object in a computing system.

In another aspect provided herein is a method for searching, recommending, and evaluating property, of a plurality of objects encoding a type of association or relation between a user and an object in a computing system.

In another aspect provided herein is a method for searching, matching, recommending, rewarding, and evaluating property, of a plurality of objects encoding a type of association or relation between a user and an object in a computing system.

In another aspect provided herein is a non-transitory computer-readable storage media configured to execute computer readable instructions, wherein the computer readable instructions comprise an object analysis and exploration module configured to search and evaluate property of a plurality of objects encoding a type of association or relation between a user and an object.

In another aspect, disclosed herein is non-transitory computer-readable storage media for used in a computing system for searching (or matching, recommending, rewarding, and combinations thereof), and evaluating property of a plurality of objects encoding a type of association or relation between a user and an object wherein the system comprises one or more physical processors in communication with said non-transitory computer-readable storage media.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a diagram that illustrates an example of a computing architecture.

FIG. 2 ERROR! Reference source not found. is a diagram that illustrates an example of a service system and work flow.

FIG. 3 shows an example of a contact management system.

FIG. 4 shows an example of a contact management module.

FIG. 5 shows an example of a communication module.

FIG. 6 shows an example of an interface of an incoming phone call.

FIG. 7 shows an example of a contact radar plot.

FIG. 8 shows an example of wish list module.

FIG. 9 shows an exemplary interface of achievements.

FIG. 10 shows an example of a list of connections after a user logged into the system.

FIG. 11 shows an example of displaying a contact's information.

FIG. 12 shows an exemplary interface allowing a user to use a search function to find a contact based on one or more criteria.

FIG. 13 shows an example of contact groups, which organized contacts into groups.

FIG. 14 shows an exemplary interface to let a user edit the groups.

FIG. 15 shows an exemplary interface to allow a user to communicate with a contact.

FIG. 16 shows an example of radar plot to visualize dimensions of contact groups and strength of the user's connections.

FIG. 17 shows an example of wish lists specified by users.

FIG. 18 shows an exemplary interface where a user helped a friend to find candidates of UI designers.

FIG. 19 shows an example of statistical summary of a wish list; in this case, Tony's wish list had been posted for one day.

FIG. 20 shows an example of mapping contact/connection management into a gaming environment.

FIG. 21 shows an example of getting appreciation certificate when a user helped a contact.

FIG. 22 shows an example of a competition ranking in a gaming environment.

FIG. 23 shows an example of a chart summarizing progress of connection establishment of a user.

FIG. 24 shows an example of a multimedia module, where the system displayed each user's multimedia collections, including photos, music, video, and etc.

FIG. 25 shows an exemplary flowchart of object exploration and analysis.

FIG. 26 shows an example of wish list processing.

### DETAILED DESCRIPTION OF THE INVENTION

The pressure of modern life due to an increasing volume of interpersonal contacts makes it increasingly difficult to manage interpersonal relationships. Yet, it's not difficult for people to be friends with others worldwide via a social network (e.g., Facebook, Instagram, Twitter, Pinterest, LinkedIn, Line, Snapchat, Skype, What's app, etc.) than before. It's almost free to share, to get entertainment, to chat, to send a message, and even to be fed news or unexpected advertisement. The social network services lure their users to input their contact lists as many as possible and add their similar characterized people recommended by the service provider. However, if the increasing volume of real and virtual contacts was to be without analyzed, evaluated, activated, identified, and tool screened, it causes inefficient. Additionally, efficient decisions of acceptance or refusal of the new invitations are sometimes difficult to make, resulting in greater difficulty in achieving success in business, problems solving and/or social life improvement.

A drawback of existing systems for object analysis, management, and exploration is unable to explore hidden information in the objects. For example, in a contact database, a list of contacts is stored in a person's computing device (e.g., smartphone, tablet, mobile computer, laptop, desktop, etc.). However, more detailed information (e.g., gender, education, family, career, etc.) regarding individual contacts can be used to leverage exploring the contacts. Further, social networks of individual contacts can be integrated to explore the contacts. In particular, when a special type of contacts is desired, using a more powerful analysis and exploration will save efforts of a user to seek the contacts. As such, a new system is described herein to automatically analyze objects (e.g., contact database) to derive useful information for users to efficiently manage the objects.

In various embodiments, described herein includes a computing system comprising a physical processor, a memory module, and an operating system configured to execute computer readable instructions, wherein the computer readable instructions comprise an object analysis and exploration module configured to search and evaluate property of a plurality of objects encoding a type of association or relation between a user and an object. In certain embodiments, the plurality of objects comprises contacts. In certain embodiments, the plurality of objects comprises individuals. In certain embodiments, the plurality of objects comprises friends.

In some embodiments, the computing system outputs a list of recommended objects with a high degree of association or relation in specific selected/random areas. In some embodiments, the association or relation is based on a wish list or a contextual need. In certain embodiments, the object analysis and exploration module searches and evaluates a potential individual dissimilar to the user, or complement to the user. In some embodiments, the object analysis and exploration module searches and evaluates a potential individual based on the individual's willingness to help other people, or based on the individual's history of helping others, or based on an incentive mechanism. In certain embodiments, the object analysis and exploration module searches and evaluates a criterion based on the user's specified wished types of objects. In certain embodiments, the criterion comprises a similar background of the user or a complement background to the user. In certain embodiments, the contextual need comprises a similarity, or a dissimilarity, or a complement based on one or more of the following characteristics selected from the group consisting of height, weight, characteristics of outward (e.g.,—skin color, eye color, hair color, body figure), gender, age, birth date, race, geographic region, computer network region, cell phone carrier, family, citizenship, residency, education, employment, employer, business unit, project, publication, industry, skill, knowledge, expertise, criminal history, willingness to help others, history of helping others, interests in others, calendar, and a history thereof. In certain embodiments, the system automatically creates a wish list for the user from analyzing a contextual need. In certain embodiments, the system automatically creates a contextual need for the user from analyzing a wish list. In certain embodiments, the system treats an element in the contextual need as an exclusive condition or an inclusive condition. In some embodiments, the plurality of objects comprises contacts, friends, or individuals. In some embodiments, the contextual need is based on a series of past activities or evens of a user. In some embodiments, the past activities or evens of the user comprise interactions of the user with the objects.

In some embodiments, the system further comprises an infographic module configured to display a summary of an object. In certain embodiments, the infographic module is further configured to display a summary of an object in a communication. In certain embodiments, the infographic module is further configured to display a summary of an object in a format of electronic marquee or scrolling text when a phone call rings.

In some embodiments, the computer readable instructions further comprise:
(1) an object management module configured to allow the user to manage the plurality of objects;
(2) an e-commerce module configured to allow the user to buy or sell a product based on auction;
(3) a multimedia management module configured to associate a medium with an object; and
(4) a rewarding module configured to reward the user based on (i) a usage degree of the system, and (ii) a degree of the user helping a plurality of individuals.

In some embodiments, the object management module is further configured to perform one or more of the following: (a) adding an object; (b) deleting an object; (c) editing information of an object; (d) viewing information of an object; (e) categorizing an object; (f) configuring a privacy rule of an object; (g) black-listing an object; and (h) white-listing an object. In certain embodiments, the object management module is further configured to allow the user to call, email, message a contact when clicking on an object comprising the contact's information. In certain embodiments, the categorizing the object comprises analyzing strength of the object associated with the user.

In some embodiments, the medium configured by the multimedia management module comprises a photo, an image, a video/audio or animation. In some embodiments, the multimedia management module is further configured to (a) allow the user to edit the medium, (b) automatically adding a location where the medium was taken and a time when the medium was taken, or (c) adding a context description of the medium. In some embodiments, the computer readable instructions further comprise a money management module configured to allow the user to spend money or receive money based on an activity in the e-commerce module or based on an outcome in the rewarding module. In certain embodiments, a currency used in the money management module comprises a virtual currency, a real currency, or a combination thereof. In some embodiments, the computer readable instructions further comprise an achievement gaming module configured to encapsulate activities of the user within a gaming framework.

In various embodiments, described herein includes a method implemented by a computing system described herein, for searching and evaluating property of a plurality of objects encoding a type of association or relation between a user and an object. In some embodiments, the computing system comprises a physical processor, a memory module, and an operating system configured to execute computer readable instructions.

In some embodiments, the method outputs a list of recommended objects with a high degree of association or relation. In some embodiments, the association or relation is based on a wish list or a contextual need. In certain embodiments, the object analysis and exploration module searches and evaluates a potential individual dissimilar to the user, or complement to the user. In some embodiments, the object analysis and exploration module searches and evaluates a potential individual based on the individual's willingness to help other people, or based on the individual's history of helping others, or based on an incentive mechanism. In certain embodiments, the object analysis and exploration module searches and evaluates a criterion based on the user's specified wished types of objects. In certain embodiments, the criterion comprises a similar background of the user or a complement background to the user. In certain embodiments, the contextual need comprises a similarity, or a dissimilarity, or a complement based on one or more of the following characteristics selected from the group consisting of height, weight, characteristics of outward (e.g.,—skin color, eye color, hair color, body figure), gender, age, birth date, race, geographic region, computer network region, cell phone carrier, family, citizenship, residency, education, employment, employer, business unit, project, publication, industry, skill, knowledge, expertise, criminal history, willingness to help others, history of helping others, interests in others, calendar, and a history thereof. In certain embodiments, the method automatically creates a wish list for the user from analyzing a contextual need. In certain embodiments, the method automatically creates a contextual need for the user from analyzing a wish list. In certain embodiments, the method treats an element in the contextual need as an exclusive condition or an inclusive condition. In some embodiments, the plurality of objects comprises contacts, friends, or individuals. In some embodiments, the contextual need is based on a series of past activities or evens of a user. In some embodiments, the past activities or evens of the user comprise interactions of the user with the objects.

In some embodiments, the method further comprises displaying a summary of an object by an infographic module. In certain embodiments, the method further comprises displaying a summary of an object in a communication by the infographic module. In certain embodiments, the method comprises displaying a summary of an object in a format of electronic marquee or scrolling text when a phone call rings by the infographic module. In certain embodiments, the method comprises displaying infographic data on/from the output unit of a user's computing device.

In various embodiments, described herein includes non-transitory computer-readable storage media configured to execute computer readable instructions, wherein the computer readable instructions comprise an object analysis and exploration module described herein configured to search and evaluate property of a plurality of objects encoding a type of association or relation between a user and an object.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Membership Management

In various embodiments, the system, platform, network, and media comprise a membership management module, or use of the same. In some embodiments, the module allows a user to enroll as a member to use the system, such as creating a password protected membership account. In some embodiments, the system allows the user to enter his/her demographic profile. In some embodiments, the membership enrollment is made via an account of a social network (e.g., Facebook, Twitter, Instagram, etc.). In additional embodiments, demographic profile is imported from an account of a social network.

In some embodiments, the membership management module enables the system to automatically exchange the profile information with a social network profile of the member.

### Graphical Modeling of Objects

In various embodiments, the system, platform, network, and media comprise an object modeling module, or use of the same. Examples of objects include individuals, contacts, companies, articles, skills, emails, messages, files, images, video files, audio files, animations, maps, movies, etc. In some embodiments, objects are described as nodes in a graph. Each object is assigned with one or more features. The features are used to describe a degree of an association between objects. The associations are described as links in the graph. In some embodiments, a method to evaluate an association is modeled probabilistically or statistically.

In some embodiments, objects are individuals on a social network. Features are the available information under an individual's account, such as traits, profile, gender, articles, jobs, skills, pictures, videos, and etc. Associations between individuals are based on a metric to characterize the link strength between individuals. In one embodiment, various types of metrics are employed to compute an association. In another embodiment, various types of associations, where a metric is used to compute a type of an association, are used. Non-limiting examples of associations are given as follows; family members have a strong degree of association; employees in a same company have a strong career association; people graduating from a same university have a strong education association; individuals publishing articles with a similar topic have a strong authorship association; professionals in a close field have a strong skill association. Depending on the practical use, determination of a graph link is based on a single type of association or is summarized from multiple types of associations.

In some embodiments, objects are contacts on a contact list. Each contact is corresponding to a graph node. Features include phone numbers, addresses, employers, etc. Basically, contacts are individuals as well. The features and association evaluations of individuals described in the previous paragraph can be applied to graphical models of contacts.

In some embodiments, objects are files. In some embodiments, features of a file include title, topic, size, location, time created, time modified, and etc. In additional embodiments, a file comprises one or more of the following: image, video, audio, sound, text, message, and email; as such, features further include scene, length, dimensions, contents inside the file, and etc.

### Object Management

In various embodiments, the system, platform, network, and media comprise an object management module, or use of the same. In some embodiments, the system allows a user to perform one or more of the following: (a) adding an object; (b) deleting an object; (c) editing information of an object; (d) viewing information of an object; (e) categorizing an object; (f) configuring a privacy rule of an object; (g) black-listing an object; and (h) white-listing an object. In some embodiments, the system automatically performs these actions based on object analysis, management, and exploration (see below)

In some embodiments, object management is realized into a more specific module. In the embodiments of the management of contact, individual, friend, or combinations thereof, objects may be contacts/individuals/friends, or any information associated with contacts/individuals/friends. In the case of management of file, image, video, or combinations thereof, objects may be files/images/videos, or any information associated with files/images/videos. Non-limiting, similar embodiments can be realized to various types of objects, e.g., articles, news, data, family, students, teachers, etc.

In embodiments of contact management, the system allows a user to perform one or more of the following: (a) adding a contact; (b) deleting a contact; (c) editing information of a contact; (d) viewing information of a contact; (e) categorizing a contact; (f) configuring a privacy rule of a contact; (g) black-listing a contact; and (h) white-listing a contact. In some embodiments, the system automatically performs these actions based on a contact analysis (see below).

In some embodiments, the system offers a user with options to maintain quantity or quality of his objects (e.g., contacts, friends, articles, files, photographs, animations, images, videos, etc.). Maintaining quantity or quality is based on various rules, pre-set by the system or by the user. To maintain a quantity of objects, when the number of objects reaches a quantity limit, the system no longer allows the user to add more objects; alternatively, when the user wants to add an object, the system automatically delete a worthless object. To maintain quality of objects, the system analyzes if the objects meet the contextual need of the user, and those quality objects are maintained in the user's database.

In some embodiments, the system presents a list of objects alphabetically. In some embodiments, the system presents a list based on quality. In some embodiments, the system presents a list based on a contextual need of the user. In some embodiments, the system presents a list based on a wish list of the user. In some embodiments, the system presents a list based on frequency of interaction between the user and its contacts.

In some embodiments when a user adds an object which represents an individual (e.g., a contact, a friend, a boss, a subordinate, a student, a teacher, etc.), the individual has an option to add, or not to add the user on the individual's own system. In some embodiments the option made by a user, it based on the user's preference in one or a plurality of individual information at that time and/or based on the selected contact's wish list, infographic of social events, or kind interaction (e.g., sharing, helping people, altruism, donation, etc.) with others.

In some embodiments, a user organizes his objects into groups. In some embodiments, objects added to a group share a similar feature. In some embodiments, objects added to a group have complement features. In some embodiments where contacts represent individuals, a feature or complement features are based on one or more of the following: height, weight, characteristics of outward (e.g., skin color, eye color, hair color, body figure), gender, age, birth date, race, geographic region, computer network region, cell phone carrier, family, citizenship, residency, education, employment, employer, business unit, project, publication, industry, skill, knowledge, expertise, criminal history, willingness to help others, history of helping others, interests in others, and a history thereof. In additional embodiments, individuals placed in a group can interact with another individual in the group.

In some embodiments where objects represent individuals, the system enables a user to call, email or message an individual when the user clicks on the individual's information. In additional embodiments, a communication is made through a telecommunication carrier (e.g., Verizon, AT&T, etc.), or through a non-telecommunication interface or application (e.g., Facebook, Instagram, Twitter, Pinterest, LinkedIn, Line, Snapchat, Skype, What's app, etc.).

In some embodiments, the system automatically categorizes an object based on analyzing strength of the association with the user. In some embodiment, the association is based on one or more of: family information (e.g., family members), education information (e.g., class in a same year or overlapping in some years), career information (e.g., working in a same place, or in an overlapping time period), frequency of the user communicating with an individual, geographic distance between the user and an individual, age difference between the user and an individual.

In some embodiments, the system allows a user to explore or view his objects. In terms of graphical representation, objects are classified into first-tier objects (i.e., directly linked to the user), second-tier objects (i.e., linked to the user with a 2-step link), . . . , till Nth-tier objects. In the example where objects are contacts, a user can explore or view his contacts (first-tier contacts), or contacts' contacts (i.e., second-tier contacts), or generally, say, Nth-tier contacts where N>1. The module allows a user to explore or view full information or partial information of an Nth-tier object.

In some embodiments where objects represent individuals, when exploring or viewing, the system allows a user to express his interest in, or willingness to help for, another Nth-tier individual. Additionally, the system records the user's history of helping others, and/or the user's history of interests in helping others.

### Object Wish List and Contextual Need

In various embodiments, the system, platform, network, and media comprise a use of a wish list. In some embodiments, the system allows a user to specify wished types of objects (e.g., individuals, contacts, friends, partners, universities, companies, entities, files, movies, and etc). In some instances, a user wants to find an object with a specific feature. In some embodiments, the user provides to the system a criterion, and the object analysis and exploration module (see below) conducts analysis to find suitable wished objects.

In some embodiments of contact management system, a user wants to find a contact with a specific characteristic in appearance or in skill. In certain embodiments, the criterion comprises a similar background or a complement background. For instance, a user lacks, or wants to have, contacts with healthcare knowledge, and he can provide such a wish list to the system; the contact analysis and exploration module will perform a search to find suitable contacts with healthcare background.

In some embodiments, a wish list excludes specific groups, or features of specific groups.

In various embodiments, the system, platform, network, and media comprise a use of a contextual need of a user. A contextual need comprises a need based on a user's condition. A context need is allowed to change over time. In some embodiments, a contextual need comprises a similarity, or a dissimilarity, or a complement based on one or more of the following: height, weight, characteristics of outward (e.g., skin color, eye color, hair color, body figure), gender, age, birth date, race, geographic region, computer network region, cell phone carrier, family, citizenship, residency, education, employment, employer, business unit, project, publication, industry, skill, knowledge, expertise, criminal history, willingness to help others, history of helping others, interests in others, calendar, and a history thereof.

In some embodiments, a wish list or a contextual need is manually provided by a user. In some embodiments, the system automatically identify a wish list or a contextual need based on various types of information of the user, such as demographics, family information, education information, career information, frequency of the user communicating with another individual, communication contents (e.g., emails, messages, phone calls, exchanged files, etc), geographic location, age difference between the user and another individual, etc.

In some embodiments, a wish list or a contextual need is valid or applicable for a certain period. A wish list or a contextual need can be changed or updated from time to time automatically by the system. The expiring period, change, or update is contingent on the user's maintenance on the wish list or the contextual need. In some embodiments, the maintenance comprises one or more of the following: reviewing the wish list, viewing/following another individual's wish list, interacting with another individual based on the individual's wish list, helping another individual based on the individual's wish list, recommending an individual based on the individual's wish list, etc.

In some embodiments, the system automatically creates a wish list for the user from analyzing a contextual need. In some embodiments, the system automatically creates a contextual need for the user from analyzing a wish list. In some embodiments, an analysis treats an element in the contextual need as an exclusive condition or an inclusive condition.

In some embodiments, the system allows a user to view or explore another individual's information, objects, networks, existing contacts, wish list, contextual need, contacts, groups, infographics or gaming information.

### Object Analysis and Exploration

In various embodiments, the system, platform, network, and media comprise an object analysis and exploration module, or use of the same. In some embodiments, an object analysis comprises three steps. Step 1: search a suitable object from existing objects; Step 2: take intelligent recommendation; Step 3: review recommended objects. For instance, in some embodiments of contact exploration and management, three steps comprise: Step 1: search a suitable contact from existing contacts; Step 2: take intelligent recommendation; Step 3: review recommended contacts. In some embodiments of friend exploration and management, three steps comprise: Step 1: search a suitable friend from existing friends; Step 2: take intelligent recommendation; Step 3: review recommended friends. In some embodiments of video exploration and management, three steps comprise: Step 1: search a suitable video from existing video files; Step 2: take intelligent recommendation; Step 3: review recommended video files. Similarly, other embodiments can be applied as well. A skilled person in the art would readily apply the similar exploration and management based on the practice of the present invention. In certain embodiments, the searching step (i.e., Step 1) is searching from the existing wish or mission list files. In certain embodiments, the reviewing step is to review the recommended wish or mission list files.

In some embodiments, input data of an object analysis comprises one or more of the following: criteria for adding an object or making a specific association (e.g., making a friend), a contextual need, a value, etc.

In some embodiments, what to be analyzed in an object analysis comprises one or more of the following: existing objects, object groups, and object dimensions. In some embodiments, the system evaluates various characteristics of objects. In some embodiments, the system automatically analyzes strength of an object associated with the user. In some embodiments, the system automatically analyzes strength of a plurality of objects associated with the user. In additional embodiments, the analysis is based on not only a user's object database but also another person's object database or other people's object databases. For instance, in an example of contact analysis and exploration, what to be analyzed in a contact analysis comprises one or more of the following: existing contacts, contact groups, and contact dimensions. In some embodiments, the system evaluates various characteristics of contacts. In some embodiments, the system automatically analyzes strength of a contact associated with the user. In some embodiments, the system automatically analyzes strength of a plurality of contacts associated with the user. In additional embodiments, the analysis is based on not only a user's contact database but also another person's contact database or other people's contact databases.

In some embodiments where objects represent individuals (e.g., contacts, friends, colleagues, etc.), evaluating property of a plurality of individuals comprises deriving a score encoding various types of association/relation, such as a familial relation, a schooling relation, and a career relation. In some embodiment, the association is based on one or more of: family information (e.g., family members), education information (e.g., class in a same year or overlapping in some years), career information (e.g., working in a same place, or in an overlapping time period), frequency of the user communicating with the contact, geographic distance between the user and an individual, age difference between the user and an individual.

In some embodiments, an object analysis outputs a list of recommended objects with a high degree of match. In some embodiments, a user is allowed to view comments or review regarding a recommended object.

In some embodiment, the analysis recommends objects to be added, or to be deleted, or both thereof. When a new object is provided to the system, e.g., manually entering by a user the new object's information or automatically acquiring the new object's information. For instance, in an embodiment where objects represent individuals, adding a new individual comprises automatically scanning a business card or acquiring the individual's information from an external database or a social network. Once an object is added, the system starts analyzing the newly added object in conjunction with the existing object databases. The analysis utilizes machine learning and artificial intelligence to identify importance of the new contact. In some embodiments, the analysis recommends the new object as a highly valuable object; however, in some situations, the analysis comments the new object as a worthless or unwanted object. The recommendations and/or comments are adaptive; a new object identified as an important/worthless object at a time can become worthless/important at another time.

In some embodiments, an object analysis takes into account various types of information in the analysis. In some embodiments where objects represent individuals, non-limiting examples of the information comprise one or more of the following: family information, education information, career information, frequency of the user communicating with the individual, geographic locations, ages, and calendar.

In some embodiments, the object analysis searches potential objects adaptively based on a current contextual need of a user. In various embodiments where objects represent individuals, the object analysis searches a potential individual similar to the user, or dissimilar to the user, or complement to the user; in additional embodiments, the similarity, dissimilarity, or complement is based on a contextual need of the user. For example, a user is a data scientist who is establishing a new startup, and now he is looking for potential collaborators. In one aspect, the object analysis helps the computer engineer search for a computer programmer, whose background is homogeneous to the user. In another aspect, the object analysis helps search for an accountant, whose background is heterogeneous to the user. Since the data scientist's existing object/individual network (e.g., contacts, friends, family members, classmates, colleagues, etc.) are mostly information technology professionals, the object analysis quickly identifies a suitable computer programmer from the first-tier or the second-tier objects. In contrast, the object analysis searches for an accountant based on a negation scheme; since there is no existing object/individual with accounting background, the object analysis searches other object/individual databases, except the user's existing object/individual network, to identify a suitable accountant.

In some embodiments where objects represent individuals, the object analysis searches for potential individuals on behalf of a user based on their willingness to help other people, or based on their history of helping others, or based on an incentive mechanism. In some applications, the object analysis searches for potential individuals satisfying the user's wish-list. In some applications, the object analysis searches for potential individuals by excluding characteristics or properties of existing object/individual network. In other words, the object analysis searches for potential individuals in a non-compatible manner.

In some embodiments, the object analysis ranks a search result. Found objects are ranked based on a user's contextual need and being recommended to the user. In additional embodiments where objects represent individuals, found individuals are ranked based on authority in a professional field. For instance, searching for an accountant for the data scientist entrepreneur lists accountants with authority in startups and data science industry.

In some embodiments, a user chooses an object based on ranking. In some embodiments, the user picks the recommended object with the highest ranking score (i.e., the best match). In some embodiments, the user picks another object not with the highest ranking score; in additional embodiments, the system requests a feedback (based on one or more open questions or one or more multiple-choice questions) from the user, and the system records the feedback to update its machine algorithm for object analysis and exploration. In some embodiments, the user rejects all the recommended objects, and the system uses the recommended objects as negation criteria to update its machine algorithm (e.g., adjusting weights, re-parameterize the algorithm, re-assemble algorithmic steps) to explore suitable objects. In one embodiment, the system equips each user with a unique algorithm; in another embodiment, the system equips each user with a unique set of parameters of a same algorithm; in another embodiment, the system uses the same algorithm and the same parameters for all the users.

In some embodiments, the recommended objects (e.g., images, files, articles, videos, contacts, friends, connections, etc) by the system are further recommended by the user to another individual. In some embodiments, the individual receiving the transferred recommendation is in the user's contact list. In some embodiments, the recommendation transfer is made automatically by the system, which analyzes suitable individuals in the user's contact list for the transfer.

In some embodiments, the object analysis automatically manages inactive objects. In some embodiments, the object analysis automatically recommends or adds objects satisfying a contextual need.

In some embodiments, the object analysis comprises a probabilistic or/and statistical algorithm to conduct searches.

### Trading

In various embodiments, the system, platform, network, and media comprise a trading module, or use of the same. In some embodiments where objects represent individuals or legal entities, the system allows a user to buy a product (including a physical product, or a service, or an e-product) from another individual/entity or sell a product to another individual/entity. In additional embodiments, a buying/selling activity is based on auction. In various embodiments, a buying/selling activity is based on a negotiation.

In some embodiments, a trading module allows exchange of services between two or more parties. For instance, a party owns expertise in business development and another party in legal service, and then these two parties exchange their services.

In some embodiments, the system allows a user or an individual/entity on the user's network to run an auction/trading/listing. Running an auction/trading/listing comprises providing product information to a user's partial or whole networks. In additional embodiments, a person interested in an auction/trading/listing is allowed to request more information of a product. The system automatically responds the information request, or allows the other part of the auction/trading to respond.

In some embodiments, the system allows a group of individuals/entities to collaborate on completing a transaction. For instance, a buyer and a seller are able to request a contact/friend/individual, who is an attorney, to review a transaction contract.

In some embodiments, the system automatically charges corresponding fees (e.g., attorney fees, accounting fees, listing fees, brokerage fees, referral fees, administrative fees, etc.).

In some embodiments, the system comprises an on/off line forum to let individuals (user, contacts, and contacts' contacts) to discuss a product.

In various embodiments, a trading module is configured to allow a user to spend money or receive money based on a trading activity or based on an outcome in an incentive module.

In some embodiments, a currency used in the trading module comprises a virtual currency, a real currency, or a combination thereof.

In some embodiments, a service involved in a trading module is not evaluated by a monetary value. In some examples, a value of a service is evaluated by another service. In some embodiment, the trading module evaluate a monetary value of a service/product, or an equivalent value of a service/produce associated to another service/product

In some embodiments, trading parties are formed by an object analysis and exploration module. When a user searches for a potential individual (e.g., contact, entity, friend, family member, colleague, an unrelated person, etc.) with a homogeneous or heterogeneous background, the system recommends and finds suitable individuals. The user can communicate with the recommended individuals to conduct a trading, such as buying, selling, auctioning, negotiating, exchanging a product or a service.

### Multimedia Management

In various embodiments, the system, platform, network, and media comprise a multimedia management module, or use of the same. A multimedia management module is configured to associate a medium with an object. Non-limiting examples of a medium include a photo, an image, a video clip, an animation, or an audio file.

In some embodiments, the system automatically performs, or allows the user to perform, editing the medium. Non-limiting examples include removing noise of a voice recording or a photo; synthesizing two segments of same-type (e.g., two images) or different-type (e.g., texts and an image) media into a single piece of medium. A person with skills in the art can easily recognize various combinations of editing media.

In some embodiments, the system automatically adds a location where the medium was taken and/or a time when the medium was taken. In some embodiments, the system analyzes the medium and infers a context of the scenario; the context description is automatically attached to the medium.

### Incentive

In various embodiments, the system, platform, network, and media comprise an incentive module, or use of the same. An incentive module is configured to provide a user with an incentive based on automatically analyzing (i) a degree of the user using the system/application, and/or (ii) a degree of the user helping individuals in his/her network. In some embodiments, a high degree allows a high reward. In some embodiments, helping an individual comprises helping the individual in an e-commerce activity. In some embodiments, helping an individual comprises answering the individual's question in an on/off forum or in a communication (e.g., call, email, message, etc.).

In some embodiments, a rewarding mechanism is based on accumulating points. In some embodiments, a rewarding mechanism comprises providing a user with a benefit, such as upgrading the user's media (e.g., images, photos, video clips, interface of gaming etc.), and/or increasing exposure of the user's media. In some embodiments, a rewarding mechanism comprises providing a user with a certificate or an un-locked object. In some embodiments, the system allows a user to access an un-locked object freely without a financial charge.

In some embodiments, the incentive module is coupled with the object analysis and exploration module. The coupling is based on altruism. An example where objects are individuals is given as follows. When a user wants to add a contact/friend/connection, the system automatically explore the existing contacts of the user, or external contacts of the user. When a potential contact is found, the system presents the potential contact to the user, and on the other hand the system presents the user to the potential contact. The system shows the matching reasons, which are based on jobs, specialty, interests, skills, wish list, and etc. In some embodiments, the system indicates how the user and the potential contact can help each other based on their jobs, specialty, interests, skills, wish list, and etc. In some embodiments, the matching is based on complementary criteria. In some embodiments, the match is based on friendliness, e.g., a history of willing to add new friends, a history of interacting with other individuals, a history of helping other individuals, a history of rejecting requests to become contacts/friends/connections.

### Infographic

In various embodiments, the system, platform, network, and media comprise an infographic module, or use of the same. In some embodiments, an infograph displays simultaneously features of existing objects. In some implementations, the features refer to elements in the contextual need.

In some embodiments, an infograph is delivered by a pie chart, a bar chart, a radar chart, a line chart, a visualized figure etc.

In some embodiments, the system uses a diagraph to display association strength.

In some embodiments, an infograph is integrated with a communication, e.g., a phone call, an email, a text message, rewarded object, appreciating object, etc. For example, when a user receives an incoming call/email, the display of the ring/email notification comprises one or more of the following regarding the caller: name, address, emails, employment, employer, one or more of any aforementioned information, past meeting summary, past meeting places, past communication contents with the user (emails, calls, messages, times, places, scenarios, contextual need, chats, etc.), current contact profiles, current association, current or past contextual needs, etc. In some embodiments, the display is static, such a text string and an image. In some embodiments, the display is dynamic, such as in one or more of the following formats: video playing, sound playing, scrolling texts, and electronic marquee.

### Achievement Games

In various embodiments, the system, platform, network, and media comprise an achievement gaming module, or use of the same. In some embodiments, an achievement gaming module encapsulates the activities of a user within a gaming framework. For instance, in some embodiments where objects represent individuals, helping people each other is described as a game, where a member accumulates awards or takes challenges. In some embodiments, the awards are real awards, or virtual awards. In some embodiments, an award has a monetary value, or can be used as a real currency or a virtual currency in an e-commerce module. In some embodiments, the achievement gaming module is coupled with the object analysis and exploration module. The coupling is based on altruism. In some embodiments, the achievement gaming module provides feedback to the object analysis and exploration module in Step 2.

### Digital Processing Device

In some embodiments, the system, network, method, and media described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the system, network, method, and media disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the system, network, method, and media disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™ JavaServer Pages (JSP), PHP Hypertext Preprocessor (PHP), Python™, Ruby, Tool Command Language (Tcl), Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™ Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™ PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the system, network, method, and media disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### EXAMPLES

The following illustrative examples are representative of embodiments of the software applications, systems, and methods described herein and are not meant to be limiting in any way. While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

### Example 1—Computing Architecture

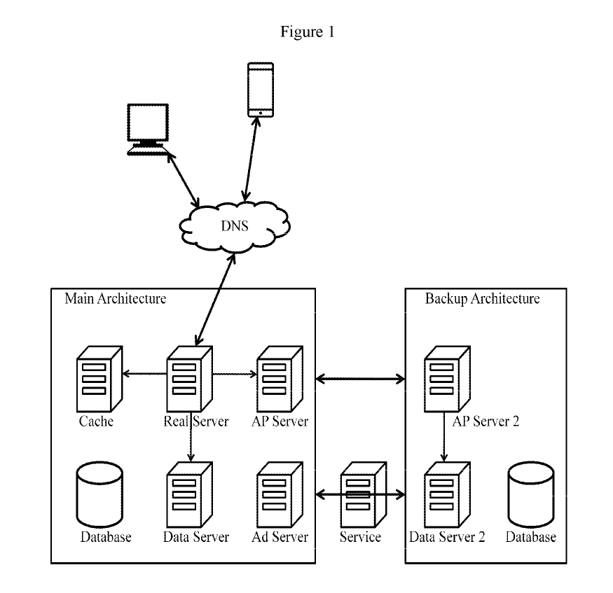

FIG. 1 illustrates an example of a computing architecture. The main architecture comprises a cache server, a real server, an AP server, a data server, an Ad server, and a database. User can access the system from his computer or smartphone (or tablet) to the real server through a computer network or a domain name service (DNS). The real server handles the user's request by processing requests with the cache, the AP server, and the data server. Moreover, the system comprises an ad server which analyzes behaviors of the user to place ads.

A system further comprises a backup architecture, which includes a second AP server, a second database, and a second data server. The backup architecture replicates the data of the main architecture in a defined period.

### Example 2—System Work Flow

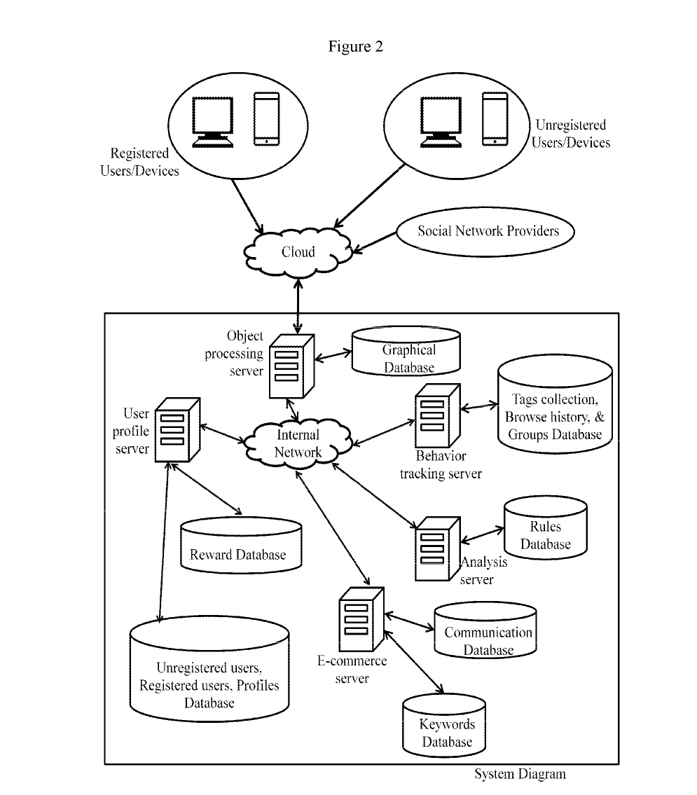

FIG. 2 shows an example of data processing flow. A user can be registered or unregistered. The system is linked to a social network medium via a computer network. The main system comprises an object processing server, a user profile server, a behavior tracking server, an analysis server, and an e-commerce server. The servers are linked via an internal/private computer network.

Alternatively, the services can be installed on a single computing machine.

Each service is associated with its databases. The object processing server is linked with a graphical database to provide a user interface. The behavior tracking server is linked with a database hosting tags collection, browse history, and groups. The analysis server is linked to a rules database to analyze contacts. An e-commerce server is linked to a communication database and a keywords database. The user profile server is linked to a reward database, and profile database.

In some embodiments, a database can be linked to another server via the internal network. For instance, a profile database is used by the analysis server to analyze association of the user with contacts.

### Example 3—Contact Management System

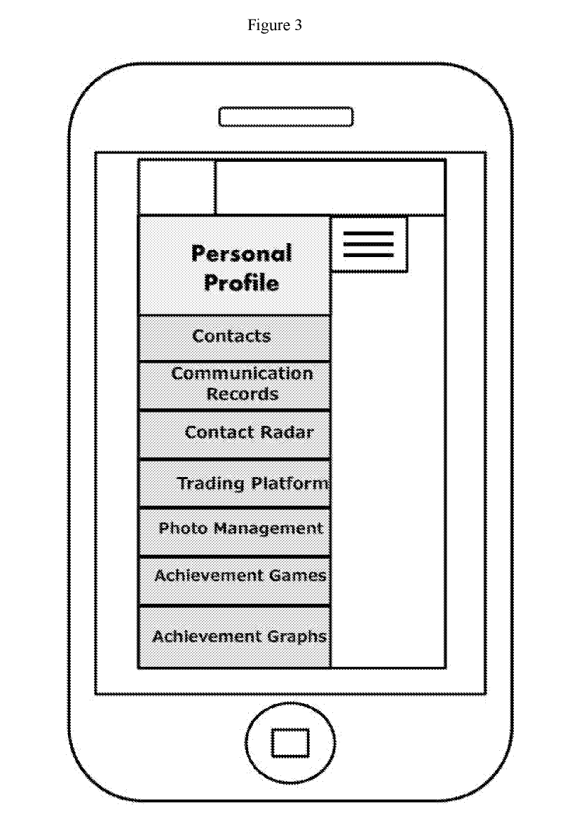

FIGS. 3-9 presents an example of a contact management system, realized by a system of object analysis and exploration disclosed herein. The system is implemented on a computing device. FIG. 3 shows an interface with various modules, such as personal profile, contacts, communication records, contact radar graph, trading platform, photo management, achievement games, and achievement graphs. Each module is a clickable button; when a user clicks a button, the interface moves to another interface to let the user explore functions on the module.

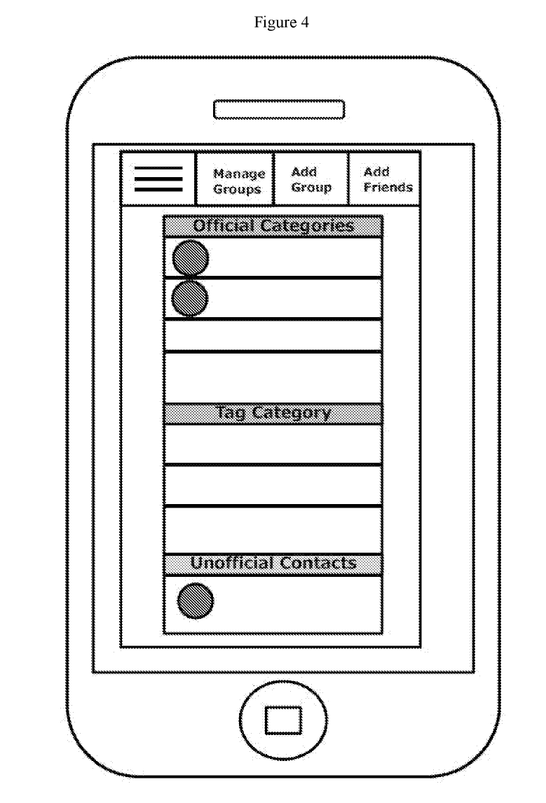

FIG. 4 shows an example of a contact management module. In this module, a user is able to add contacts, add groups, and categorize contacts into groups. In this example, the system by default has official categories. The user is allowed to add new groups or assign tags to contacts which form various groups.

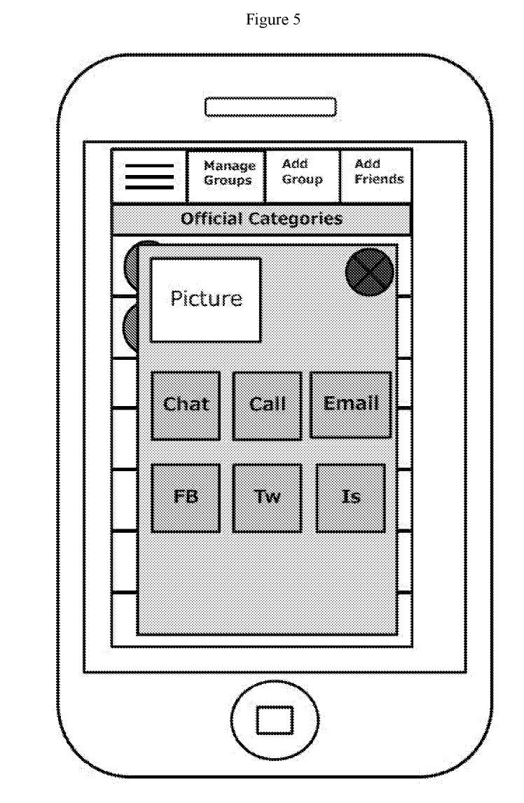

FIG. 5 shows an example of a communication module. When selecting a contact, the system displays more information of the contact. Further, the system shows an interface to let the user choose a communication method, such as chat, call, or email. Furthermore, the communication module is linked to one or more social networks, such as Facebook, Twitter, or Instagram.

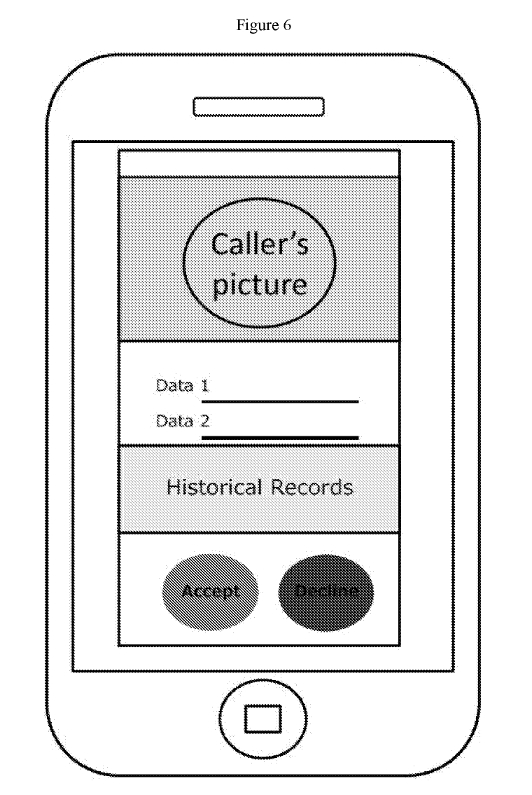

FIG. 6 shows an example of an interface of an incoming phone call. When a call comes, the system displays the caller's information, such as caller's picture, caller's data, and historical records associated with the caller.

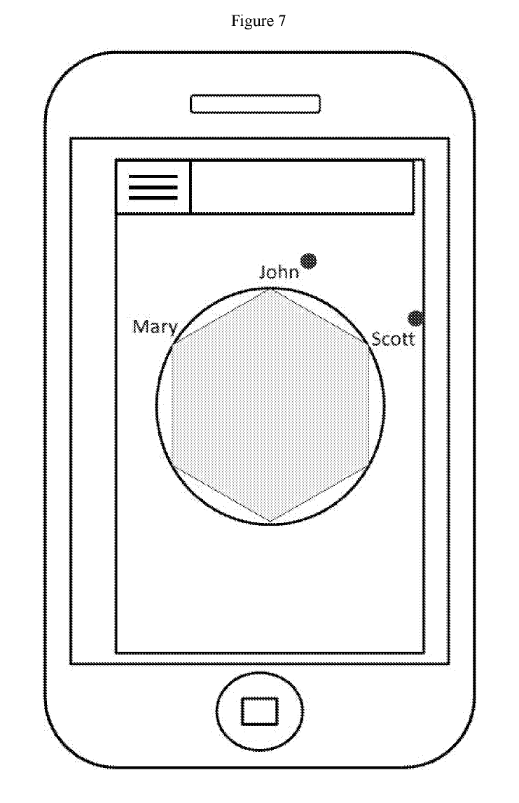

FIG. 7 shows an example about a radar plot of contact groups. A radar plot is a polygon where a vertex denotes a dimension of a contact groups. In the radar plot, contact groups are placed at the vertex of a polygon to represent the relative contact number among those selected contact groups of the user.

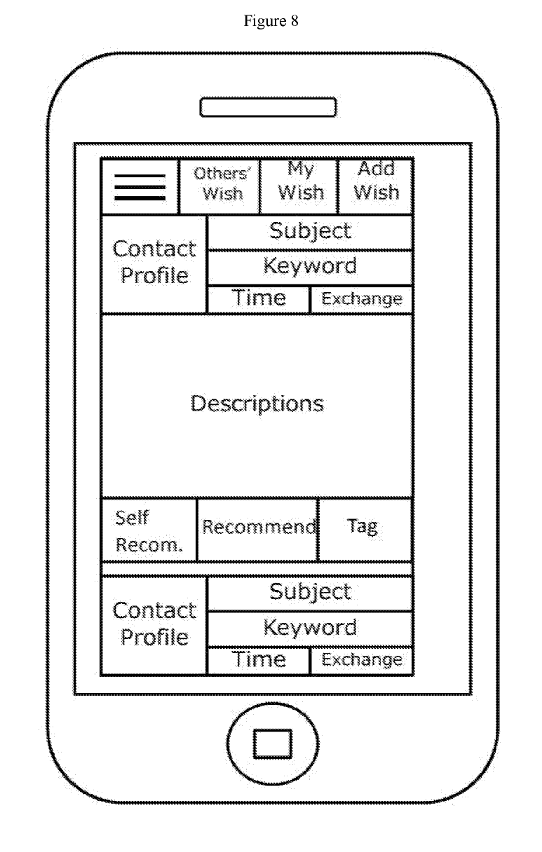

FIG. 8 shows an example of wish list module. In this module, a user can add wished contacts by specifying desired characteristics. Moreover, the user is allowed to explore other contact's wish list. Further, the user is allowed to perform various actions within this module. Examples of the actions include self-recommend to a contact, recommend a person to a contact, tag the wish list, search possible contacts, perform intelligent recommendation for the user, and edit a wish list.

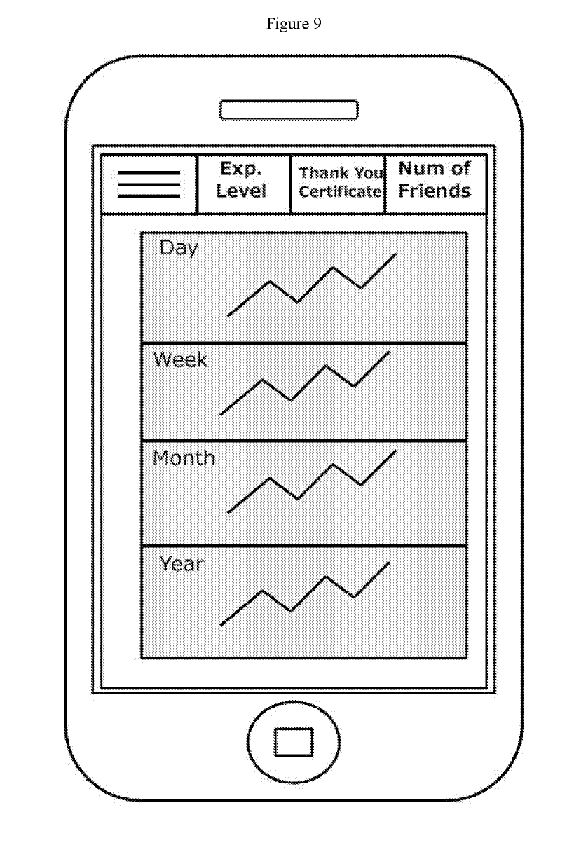

FIG. 9 shows an example interface of achievements. In this example, helping a contact or a contact's network adds achievement points to the user. The plots organized by time periods show how the user's achievements grow over time.

### Example 4—Contact and Connection Exploration System

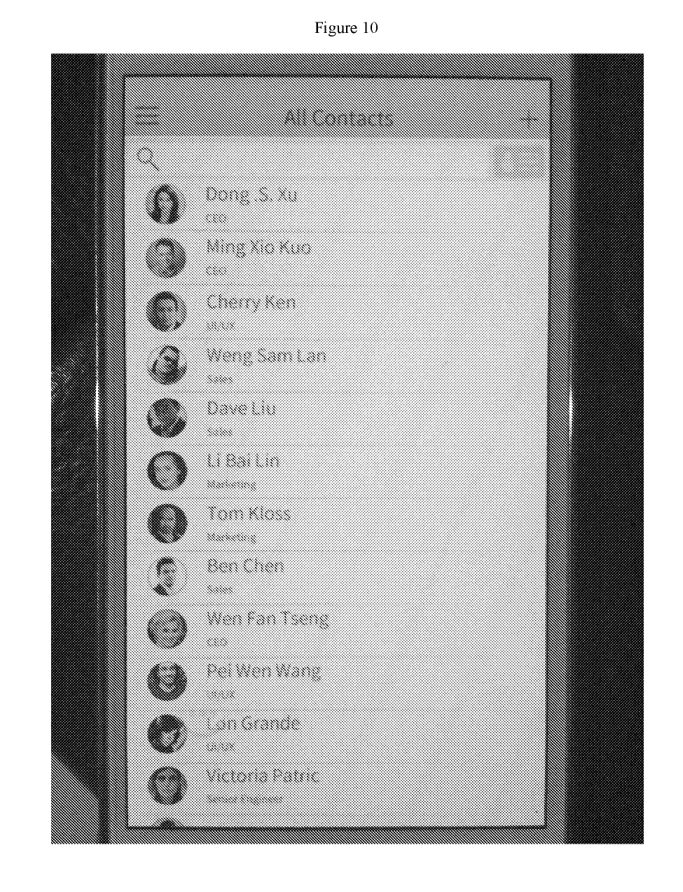

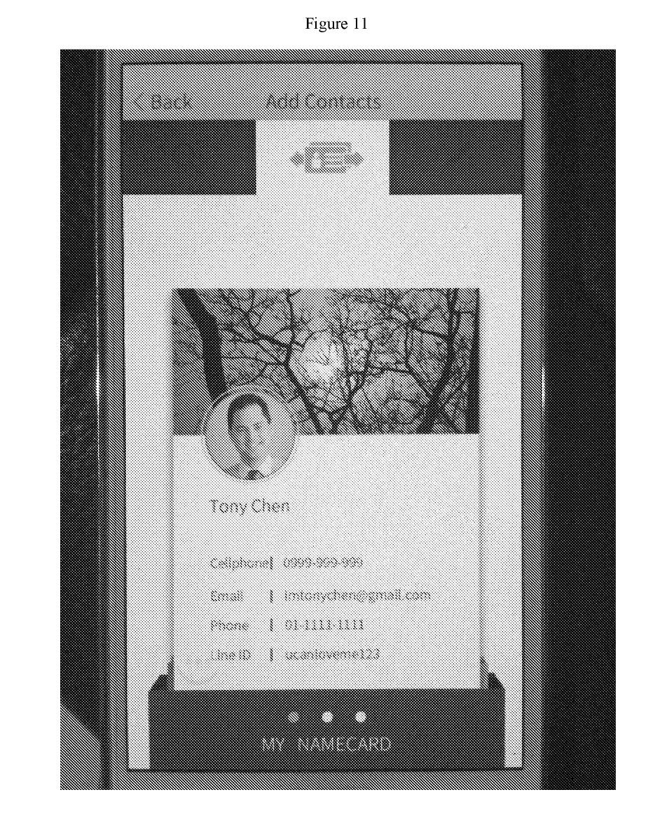

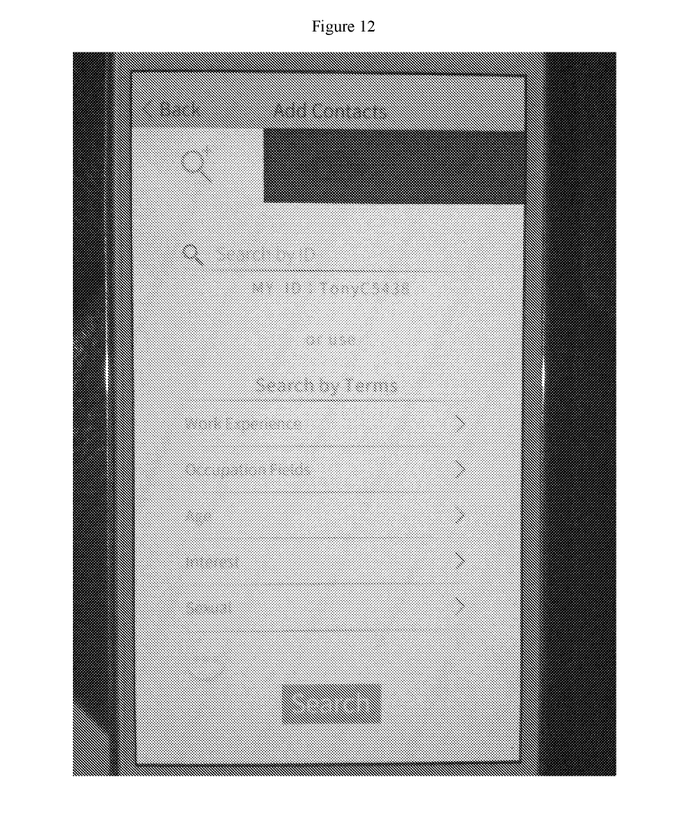

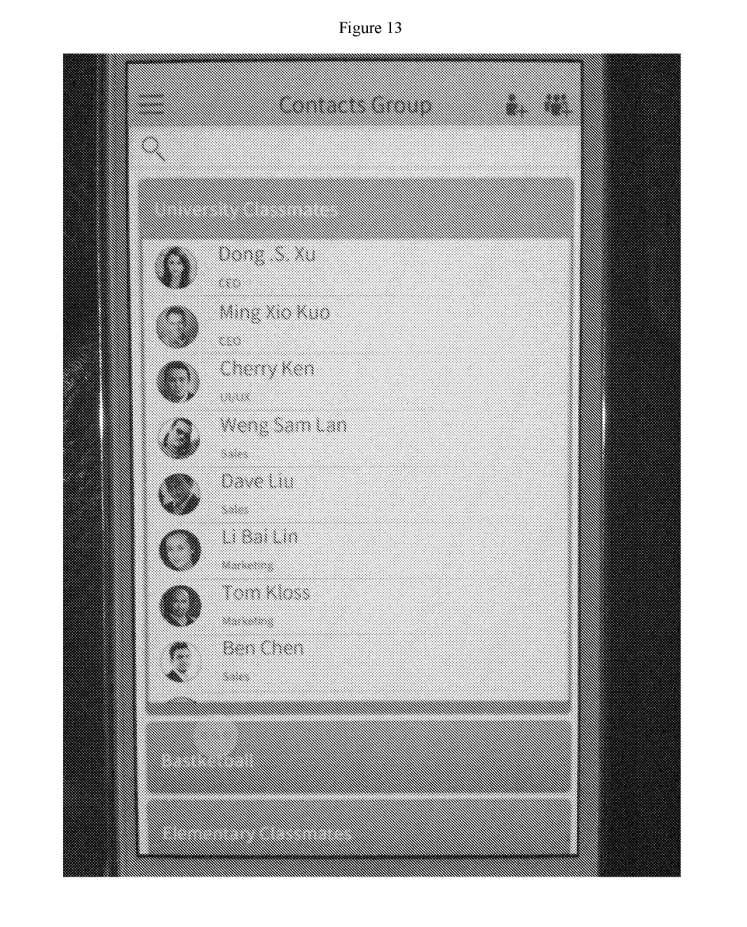

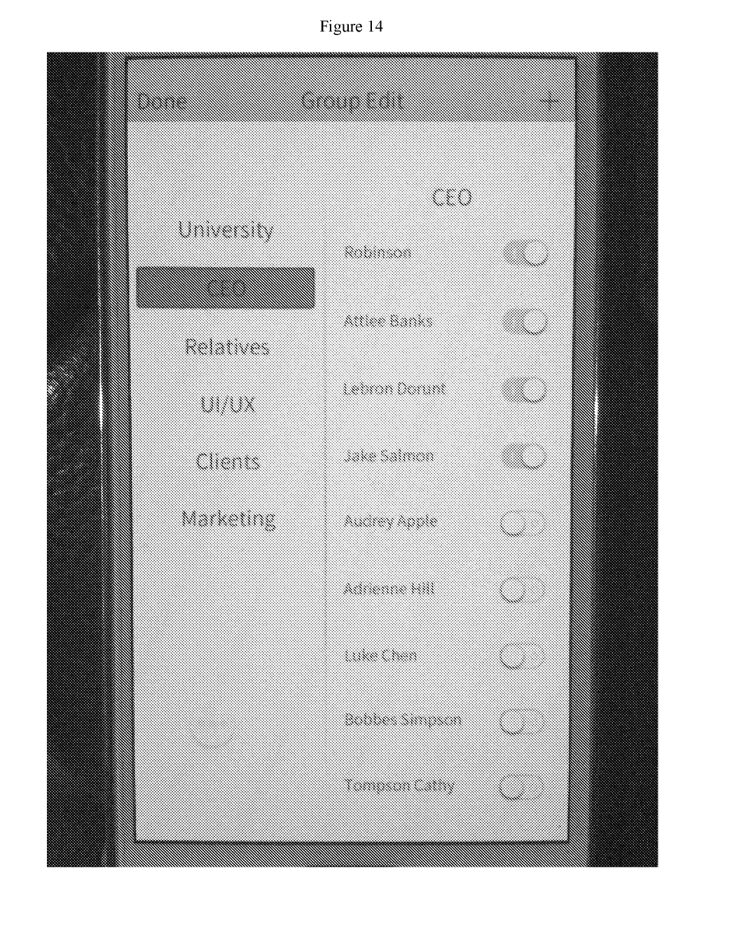

FIGS. 10-24 presents an example of a connection management system, realized by a system of object analysis and exploration disclosed herein. The system is implemented on a computing device. The computing system comprised a display to allow a user to access the software modules. Once the user logged into the system, the system showed a list of connections, e.g., see FIG. 10. Referring to FIG. 11, when the user clicked a contact, the system showed detailed name card. Alternatively, the user could use a search function (see FIG. 12) to find a contact; the search function allowed the user to enter criteria for the search. Contacts shown in FIG. 11 were further organized into contact groups, shown in FIG. 13; in this example, three contact groups are shown: university classmates, basketball friends, and elementary classmates. The user was able to edit the groups. FIG. 14 shows an interface to let the user edit the groups; in this example, six groups (University, CEO, Relatives, UI/UX, Clients, and Marketing) had been set up and each contact was belonging to a particular group was switched on when the user configured the group.

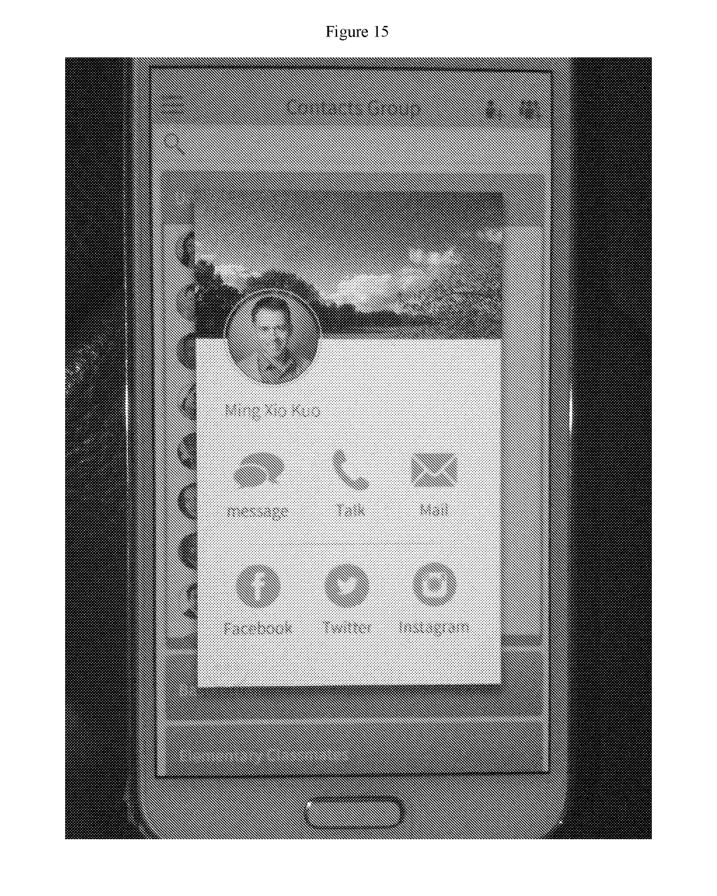

This example further allowed the user to communicate with a contact. Referring to FIG. 15, a contact's communication information was popped up, and the user could choose a communication method, such as email, phone call, text message, or social networking.

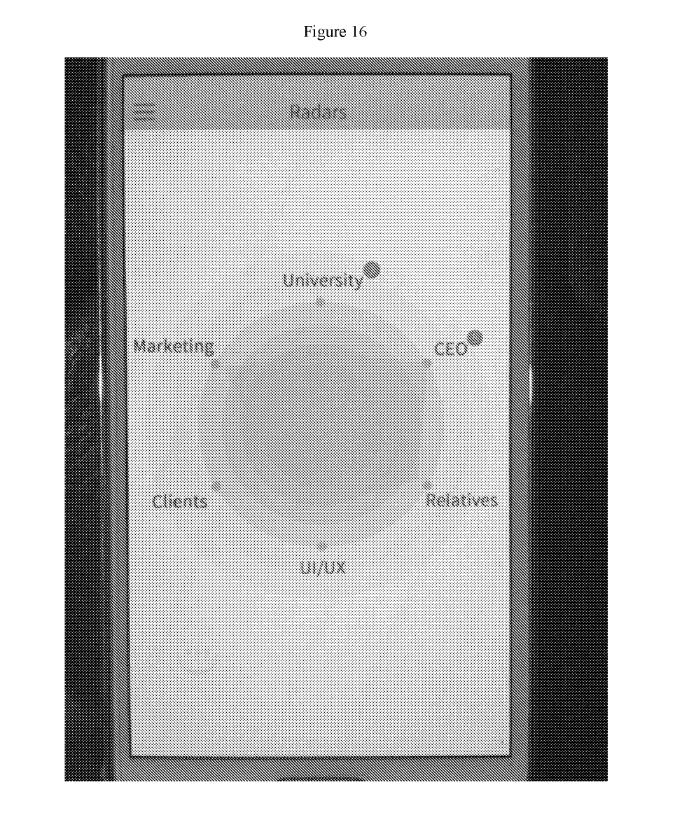

The contact groups were further visualized by a radar plot, see FIG. 16. The radar plot displayed the dimensions of the contact groups, allowing the user to visualize the strength of the user's connections.

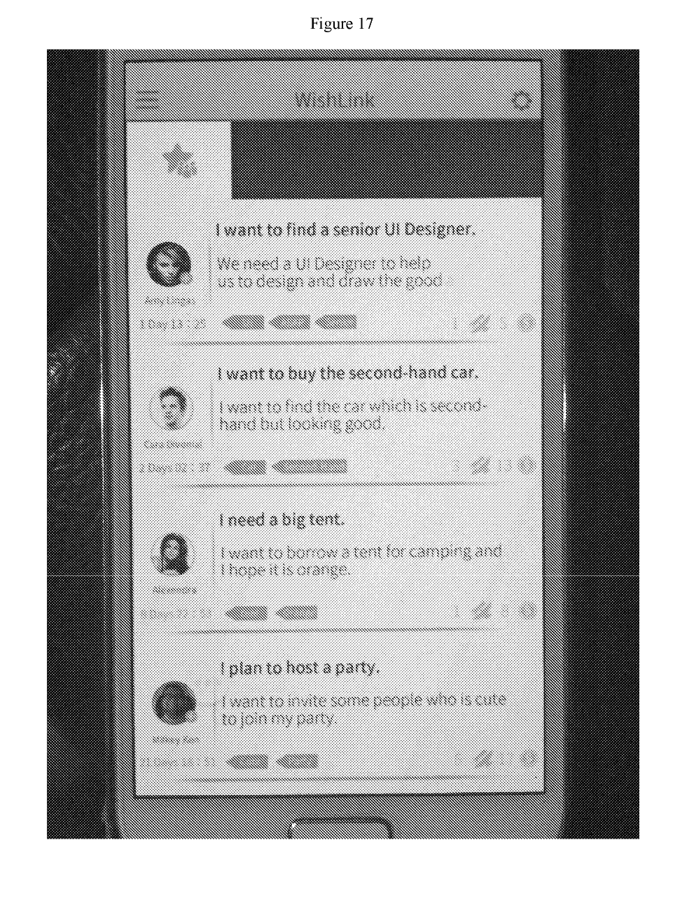

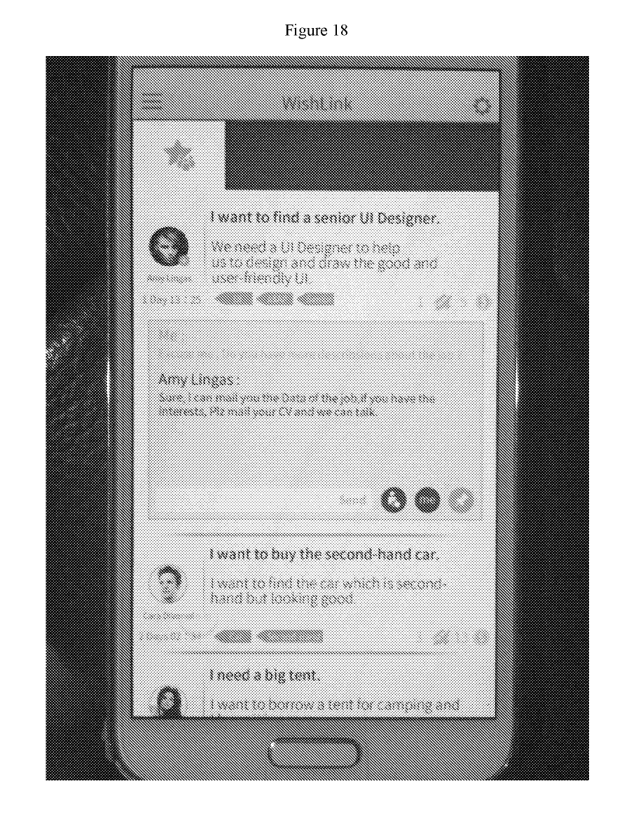

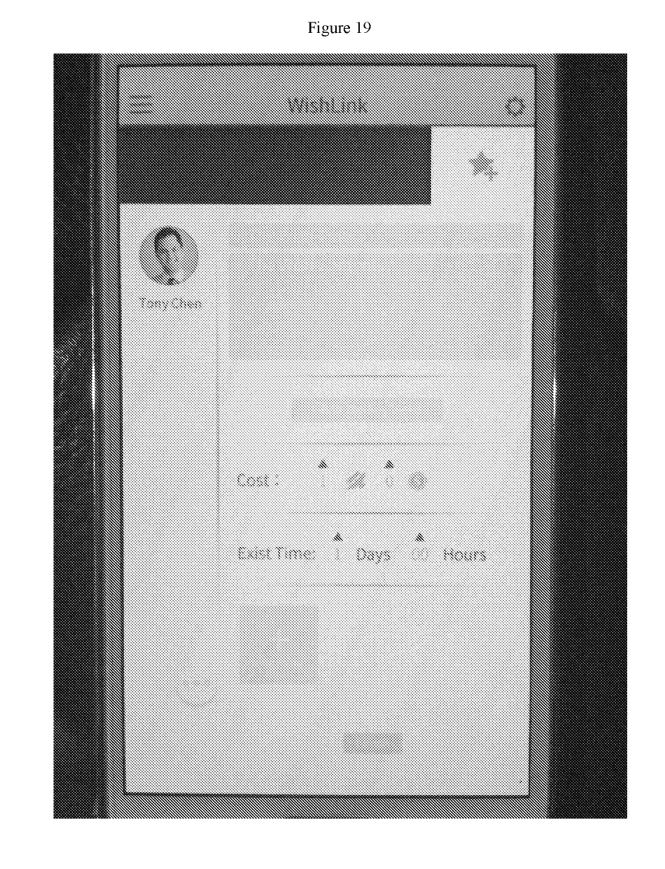

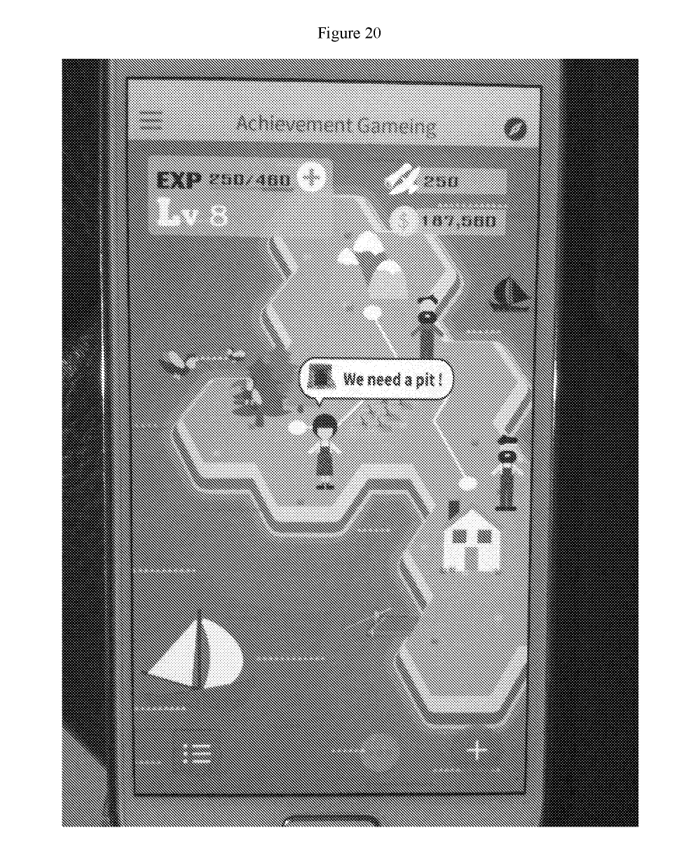

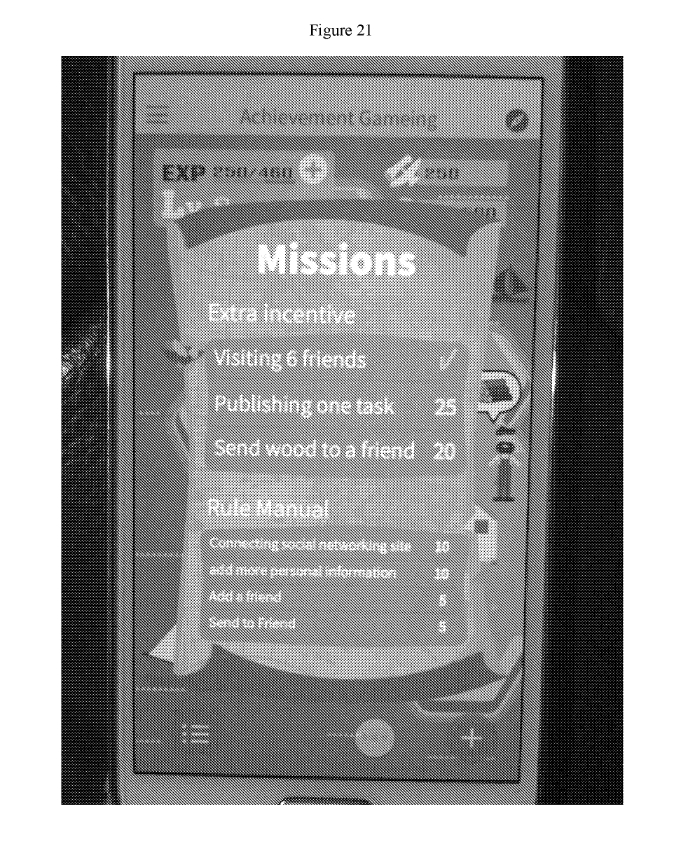

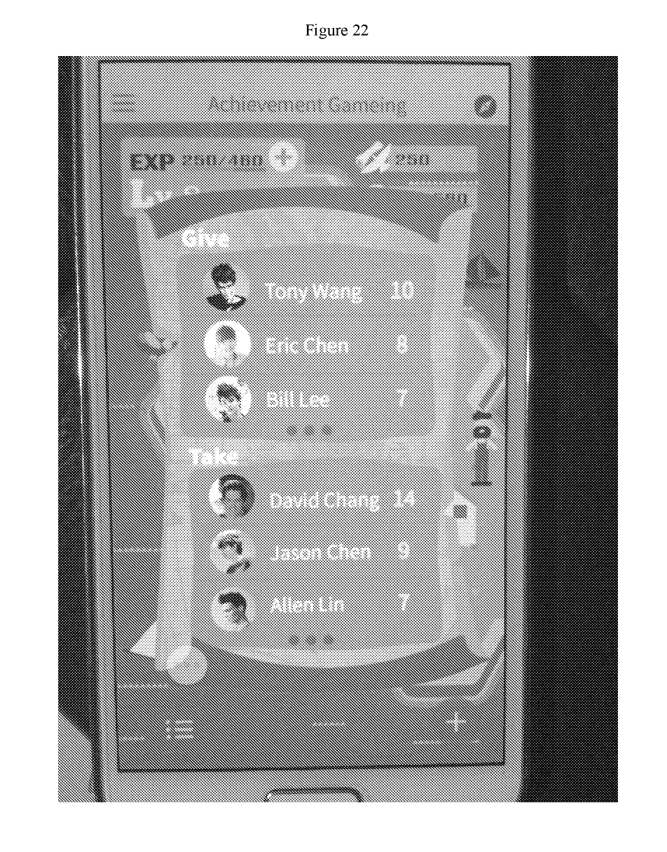

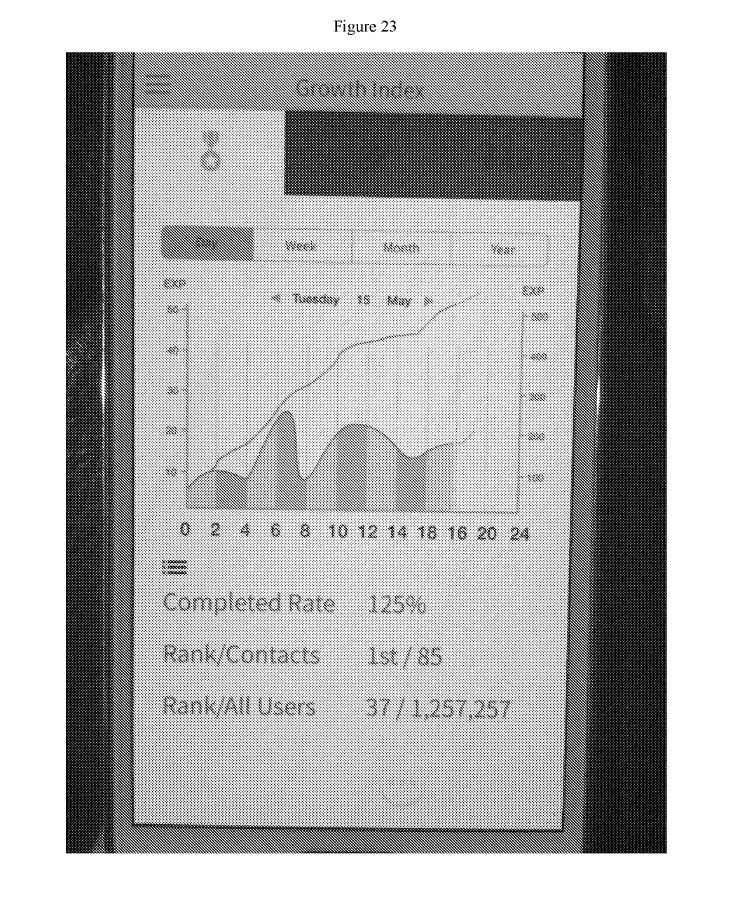

Referring to FIG. 17, the system allowed users to specify their wish lists. In this example, a contact Amy wanted to find a senior UI designer; another contact wanted to buy a second-hand card; another contact needed a tent; another contact planned to host a party. Referring to FIG. 18, the user further helped Amy via a real-time chat where the user offered to pass good candidates of UI designers. Furthermore, the system summarized statistics of a wish list; for example, FIG. 19 shows that Tony's wish list had been posted for one day. To make the contact and connection management more fun, the connections were formed in a gaming environment. In FIG. 20, contacts were mapped to players in a game, where friend connections, communications, and helping people were simulated as competitions. For example, helping other people could get an appreciation certificate. The user could set up a goal in the game, see FIG. 21. A competition ranking was summarized in FIG. 22. Further, a chart summarizing the progress of connection establishment was shown in FIG. 23.

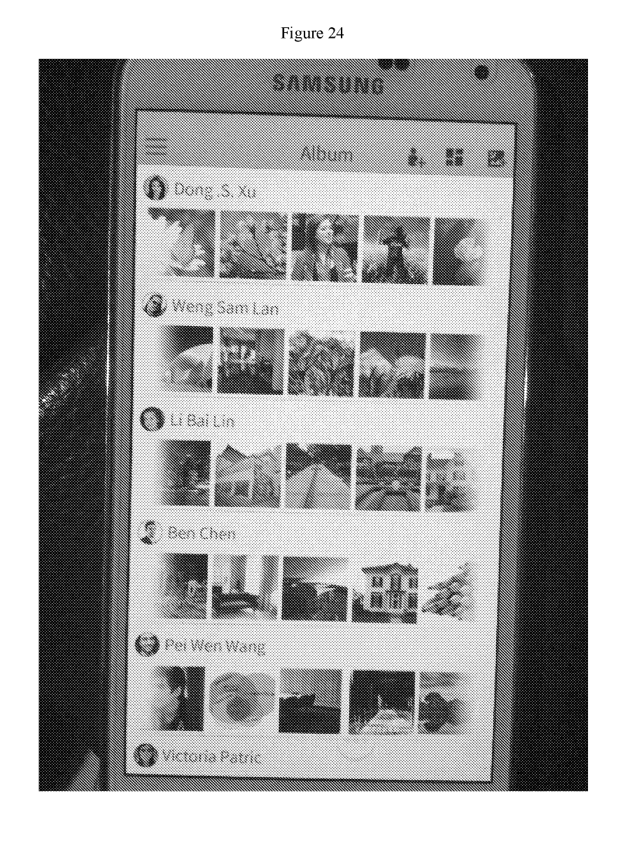

The system also had a multimedia module where users could upload their multimedia files. Referring FIG. 24, the system displayed each user's multimedia collections, including photos, music, video, and etc. The user can see shared multimedia files from a contact.

### Example 5—Flowchart of Object Exploration and Analysis

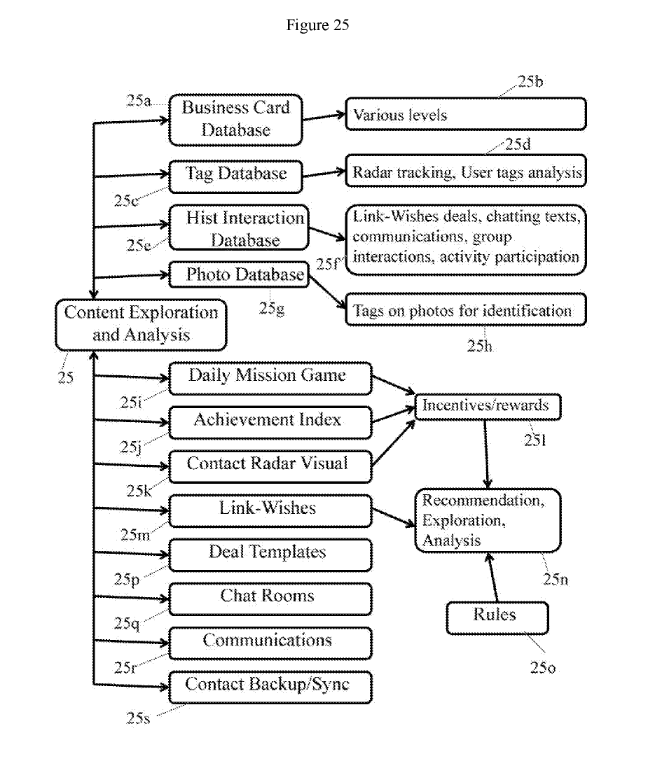

A contact exploration and analysis system comprises database of contacts. FIG. 25 presents an exemplary flowchart of object exploration and analysis. For the illustration purpose, the objects used in this example are contacts (shown in block 25 as Contact Exploration and Analysis). A person of ordinary skill in the art can readily extends the practice of the present invention to other types of objects, such as articles, images, videos, files, and etc.

In this example, a contact database comprises a business card database 25a. The contact database or the business card database is categorized into various levels 25b, such as private level, friend level, business level, and social level. Categorization is done manually or processed automatically by analyzing information enclosed by the contacts or social networks. The system further comprises a tag database 25c. Tags are automatically assigned by the system to any objects (not only contacts, but also images, files, videos, audios, texts, messages, phone calls, history, and etc) and features/properties describing the objects. Tags are also used to identify people and objects. For example, faces in a photo are tagged and each tag corresponds to a person's name, feature, family and etc. Tags are used to track and analyze users of systems (block 25d). Tags are used to track any information to be displayed on a radar plot/chart.

The system further comprises a database of historical interactions 25e, such as communications (e.g., emails, text messages, phone calls, and etc) and group participations as shown in block 25f. Group participations include actions in a group or interactions with another person. The interactions also include any interactions related to wish-list. In some instances, the interactions include deals in e-commerce/trading, gaming activities, and/or assisting other people.

The system further comprises a database of multimedia. In this example, the multimedia database comprises a photo database 25g. A multimedia object is analyzed assigning one or more tags (e.g., tags on photos for identification as shown in block 25h). A tag includes a person's information (e.g., name, contact, address, etc.), feature, property, education, interaction, activity, topic, place, and/or time.

The system further comprises a gaming module. In this example, the gaming module comprises a daily mission game 25i and an achievement index 25j. The system also comprises an infographic module where contacts are displayed as a radar chart (i.e., contact radar visual 25k). The radar chart is linked with the gaming module so that the information of gaming module can be displayed on the radar chart. The daily mission game, achievement index, and radar visual are further linked and analyzed to provide incentives and rewards 251 for users. In the design, the incentives and rewards can be fed back to the daily mission game 25i to motivate/remind the users to conduct more interactions. In addition, the incentives and rewards are fed back to the exploration and analysis to daily mission game to motivate/remind the users to conduct more interactions.

The system further comprises a module to process wish lists. A wish list is generated by a user, or generated automatically from inferring a contextual need of the user. Inference is made by analyzing any information available, including but not limited to contacts, features, properties, incentives, games, deals, educations, family, communications, interactions, and tags (as of analysis). Once a wish list is generated, a recommendation engine is followed to make searches and analyses to recommend most suitable objects matching the wish list (as of exploration and recommendation). The user can select a match from the recommendation list, or reject a recommend so that the recommendation engine updates its search algorithm or parameters to execute new searches. The analysis, recommendation, and exploration are shown in block 25n.

In some embodiments, the system further comprises a rule module for the recommendation engine processing. One or more rule (such as block 25o) can be set up manually. For example, the system utilizes similarity or complement as a rule for a search. In some embodiments, the system also considers other contacts' preferences. For example, a contact does not want to be recommended forever, and the recommendation does not take into this contact for the analysis. Various types of rules taken into account comprise, for example, regions, languages, backgrounds, contact radar plot, group analysis, and keywords in wish lists. In some embodiments, the recommendation engine considers the preference derived from the incentives/rewards and user behaviors. The operations of the recommendation are triggered by a user, or automatically by the system when the system detects or is triggered a necessity.

The system further comprises a number of add-ons. For example, to facilitate the trading, templates of trades/deals as in block 25p are provided. The system comprises a chat room 25q so users can exchange their information or their wish lists. The system comprises a communication module so users can easily conduct communications as in block 25 r (emails, text messages, phone calls, meetings, etc.). The system comprises an object backup module to duplicate objects in another location. The system comprises an object synchronization module to synchronize objects across platforms and users. Block 25s shows both contact backup and synchronize modules.

### Example 6—Wish List Processing

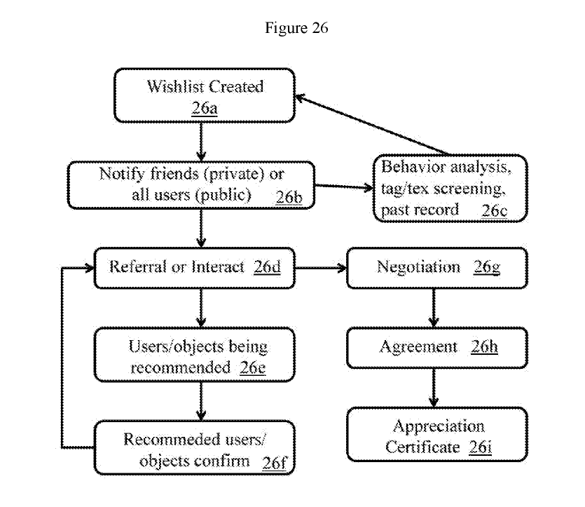

FIG. 26 shows an example of wish list processing. A wish list contains a specific skill or expertise, or in some applications a wish list contains an object. As illustrated in block 26a, a wish list is created by a user or by a contextual need. The creation of the wish list is based on a behavior analysis, a tag/text screening and/or a past record (block 26c). Once a wish list is created, the system explores a first tier of objects (e.g., friends) or other tiers of objects (e.g., friends' friends and possibly all users) (block 26b). Sometimes, a friend refers and recommends a person to the user. In some instances, the system explores all the users matching the criteria of the wish list and makes recommendations. The friend's referral or the system's recommendation is illustrated in block 26d.

When an object/person with a good match is found, the system presents the recommended object/person to the user (block 26e). The user either declines or accepts. In block 26f, when a decline is made or confirmed, the system reinitiates the exploration by adjusting its internal parameters. When the user accepts the recommended object/person, the user or the recommended person/owner or both have an option to add the counter party as a friend. Upon acceptance the user negotiates (as in block 26g) the person or the owner of the object regarding the need specified in the wish list. Once an agreement is reached (as in block 26h), the user and the recommended person/owner make a transaction, followed by an appreciation certificate (block 26i) issued to the recommended person/owner.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computing system comprising a physical processor, a memory module, and an operating system configured to execute computer readable instructions, wherein the computer readable instructions comprise an object analysis and exploration module configured to search and evaluate property of a plurality of objects encoding a type of association or relation between a user and an object.

2. The computing system of claim 1, wherein the plurality of objects comprises contacts.

3. The computing system of claim 1, wherein the plurality of objects comprises individuals.

4. The computing system of claim 1, wherein the plurality of objects comprises friends.

5. The computing system of claim 1, wherein the computing system outputs a list of recommended objects with a high degree of association or relation.

6. The computing system of claim 1, wherein the association or relation is based on a wish list or a contextual need.

7. The computing system of claim 1, wherein the object analysis and exploration module searches and evaluates a potential individual dissimilar to the user, or complement to the user.

8. The computing system of claim 1, wherein the object analysis and exploration module searches and evaluates a potential individual based on the individual's willingness to help other people, or based on the individual's history of helping others, or based on an incentive mechanism.

9. The computing system of claim 6, wherein the object analysis and exploration module searches and evaluates a criterion based on the user's specified wished types of objects.

10. The computing system of claim 9, wherein the criterion comprises a similar background of the user or a complement background to the user.

11. The computing system of claim 6, wherein the contextual need comprises a similarity, or a dissimilarity, or a complement based on one or more of the following characteristics selected from the grouping item consisting of height, weight, characteristics of outward, gender, age, birth date, race, geographic region, computer network region, cell phone carrier, family, citizenship, residency, education, career history records, business, project, publication, industry, skill, knowledge, expertise, criminal history, willingness to help others, history record of helping others, interest areas, calendar, and a history thereof.

12. The computing system of claim 6, wherein the system creates a wish list for the user from analyzing a contextual need.

13. The computing system of claim 12, wherein the system creates a contextual need for the user from analyzing a wish list.

14. The computing system of claim 13, wherein the system treats one or more element in the contextual need as exclusive condition(s) or inclusive condition(s).

15. The computing system of claim 6, wherein the contextual need is based on a series of past activities of the user.

16. The computing system of claim 15, wherein the past activities of the user comprise interactions of the user with the objects.

17. The computing system of claim 1, wherein the system further comprises an infographic module configured to display a summary of an object.

18. The computing system of claim 17, wherein the infographic module is further configured to display a summary of an object in a communication.

19. The computing system of claim 17, wherein the infographic module is further configured to display a summary of an object in a format of electronic marquee or scrolling text when a phone call rings.

20. The computing system of claim 17, wherein the infographic module is further configured to display a summary of an object in an infographic record of the user's operation data or interact data.

21. The computing system of claim 1, wherein the computer readable instructions further comprise:
(1) an object management module configured to allow the user to manage the plurality of objects;
(2) an e-commerce module configured to allow the user to buy or sell a product or service based on auction;
(3) a multimedia management module configured to associate a medium with an object; and
(4) a rewarding module configured to reward the user based on (i) a usage degree of the system, and (ii) a degree of the user helping one or more individuals.

22. The computing system of claim 21, wherein the object management module is further configured to perform one or more of the following: (a) adding an object; (b) deleting an object; (c) editing or updating information of an object; (d) viewing information of an object; (e) categorizing an object; (f) configuring a privacy rule of an object; (g) black-listing an object; and (h) white-listing an object.

23. The computing system of claim 22, wherein the object management module is further configured to allow the user to call, email, or message one or more contacts when clicking on an object comprising the contact's information.

24. The computing system of claim 22, wherein the categorizing the object comprises analyzing strength of the object associated with the user.

25. The computing system of claim 21, wherein the medium configured by the multimedia management module comprises a photo, an image, a video, an audio, or a graphic message.

26. The computing system of claim 21, wherein the multimedia management module is further configured to (a) allow the user to edit the medium, (b) automatically adding a location where the medium was taken and a time when the medium was taken, or (c) adding a context description of the medium.

27. The computing system of claim 21, wherein the computer readable instructions further comprise a money management module configured to allow the user to spend money or receive money based on an activity in the e-commerce module or based on an outcome in the rewarding module.

28. The computing system of claim 27, wherein a currency used in the money management module comprises a virtual currency, a real currency, or a combination thereof.

29. The computing system of claim 21, wherein the computer readable instructions further comprise an achievement gaming module configured to encapsulate activities of the user within a gaming framework.

30. The computing system of claim 29, wherein the achievement gaming module comprise the plurality of levels for the user operating the achievement game.

31. A method, implemented by a computing system of claim 1, for searching and evaluating property of a plurality of objects encoding a type of association or relation between a user and an object in said computer system.

32. The method of claim 31, wherein the method further comprises displaying a summary of an object in a communication by the infographic module.

33. The method of claim 31, wherein the method comprises displaying a summary of an object in a format of electronic marquee or scrolling text when a phone call rings by the infographic module

34. The method of claim 32, the method comprising displaying infographic data on/from the output unit of a user's computing device.

35. A non-transitory computer-readable storage media configured to execute computer readable instructions, wherein the computer readable instructions comprise an object analysis and exploration module configured to search and evaluate property of a plurality of objects encoding a type of association or relation between a user and an object.
